(19) United States
(12) Patent Application Publication
(10) Pub. No.: US 2018/0304788 A1
(43) Pub. Date: Oct. 25, 2018

(54) CONTROLLED MOVEMENT OF THE ARMREST

(71) Applicant: MOTHERSON AUTOMOTIVE TECHNOLOGIES & ENGINEERING (A DIVISION OF MOTHERSON SUMI SYSTEMS LTD.), Noida (IN)

(72) Inventor: In Muk PARK, Incheon (KR)

(73) Assignee: MOTHERSON AUTOMOTIVE TECHNOLOGIES & ENGINEERING (A DIVISION OF MOTHERSON SUMI SYSTEMS LTD.), Noida (IN)

(21) Appl. No.: 15/767,999

(22) PCT Filed: Oct. 13, 2016
(86) PCT No.: PCT/IB2016/056114

§ 371 Date: Apr. 12, 2018

(30) Foreign Application Priority Data
Oct. 14, 2015 (IN) 3313/DEL/2015

(51) Int. Cl. B60N 2/75

(52) U.S. Cl. CPC B60N 2/767

(57) ABSTRACT

In the present invention, an armrest (100) having a controlled movement pivoted to the console utility box (110) of a vehicle is comprised. The armrest (100) comprises an armrest assembly (130), a hinge (140) an elongated shaft (300), a damper plate assembly (302) and a spring assembly (306). Also, the present invention covers unique pivot arrangement in the armrest assembly (130), wherein said pivot arrangement facilitates a controlled movement of the armrest (100) and wherein the controlled movement is characterized by a damped movement within at least one specific angular range and a non-damped movement within at least one different angular range.

### FIELD OF INVENTION

The present invention relates to an automotive component, and more particularly, to an armrest assembly having controlled movement.

### BACKGROUND OF THE INVENTION

Now a days, automobiles are not considered a mere means of transport and instead the user demands a higher level of comfort and luxurious features in their automobile interiors. Therefore, modern automotive interiors of the automobiles include various features and accessories intended to improve the comfort and convenience of the users. For example, automobiles are commonly provided with a center console located between the front seats. As shown in FIG. 1, the center console typically includes an armrest, various storage bays and compartments, cup and coin holders, and other accessories for improving the comfort and convenience of the vehicle occupant. The armrest are generally moveable from a first position to the second position, wherein the first position is characterized by a horizontally aligned and closed position of the armrest, and the second position is characterized by vertically aligned and open position of the armrest. While the closed position is convenient for occupants to rest their arms, the open position permits an access to the storage compartment. The presently available products in the market exhibit sharp, uncontrolled and jerky angular movement of the armrest between the horizontal and vertical position often leading in injury to the person seated on the back side of the assembly.

The uncontrolled angular movement of the armrest is also not favorable as the interim positions are aesthetically unpleasing.

In the past, controlled movement of the armrest had been achieved, however, with complex built in structures and increased manufacturing time and quality of such complex pivotal units. Therefore, there is a need for a cost effective and novel way of achieving controlled movement of the armrest. There also is a need for solutions which are easy to manufacturing and reduce assembling time.

A need therefore exists for a comfortable armrest that addresses the aforementioned and other problems of the prior art.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF THE INVENTION

This section is provided to introduce certain objects and aspects of the disclosed methods and systems in a simplified form that are further described below in the detailed description. This summary is not intended to identify the key features or the scope of the claimed subject matter.

In view of the shortcomings of existing methods and systems, as discussed in the background section, it is apparent that there exists a need to provide a comfortable and easy to use arm rest for an automotive. It is also an object of the present invention to provide smooth and non-jerky angular movement of the armrest in the horizontal plane, thereby ensuring safety of the passengers from any injuries caused due to jerky and rough movement of the armrest. It is further object of the invention to provide controlled angular movement of the armrest such that the user can not open or close the armrest at the desired pace and position.

Accordingly, the present invention relates to an armrest having a controlled movement pivoted to the console utility box 110 of a vehicle. The armrest 100 comprises an armrest assembly 130 and an armrest hinge 140 of the armrest assembly; an elongated shaft 300 pivotally fixes the armrest assembly 130 with the console utility box 110 of the vehicle, wherein the shaft 300 bearing a polygon circumference towards its outer surface, at least at torsion spring one position along the length of the shaft 300; a damper plate assembly 302 fastened on the console utility box 110 which functionally interacts with said at least one outer polygonal surface on the shaft to provide the damping effect on the controlled movement of the armrest 100 in a specific angular range; and a spring assembly 306 functionally engaged with the armrest assembly 130, the hinge 140 of the armrest assembly 140, the shaft 300 and the damper assembly 302 to facilitate controlled movement of said armrest 100.

Other objects, features, and advantages of the present invention will become apparent from the following detailed description.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Also, the embodiments shown in the figures are not to be construed as limiting the invention, but the possible variants of the method and system according to the invention are illustrated herein to highlight the advantages of the invention.

FIG. 1 demonstrates a typical automobile console utility box with the armrest.

FIG. 2 and FIG. 3 demonstrates a side view of the armrest pivoted on the console utility box.

FIG. 4 demonstrates the various angular positions of the armrest with respect to the console utility box.

FIG. 5 demonstrates a pivot arrangement.

FIG. 6 demonstrates a closer view of a shaft with a damper assembly.

FIG. 7 demonstrates a closer view of the damper assembly with its damper members.

FIG. 8 demonstrates various interactions of the shaft and the damper member during the movement of the armrest.

FIG. 9a and FIG. 9b demonstrate various requirements of the operation forces on the armrest as encompassed by the invention.

### BRIEF DESCRIPTION OF INVENTION

The following paragraphs describe various aspects and features of the invention in way of embodiments and illustrations. The features covered herein can each be used independently of one another or with any combination of other features. However, an individual feature might only address one of the problems discussed above. Some of the problems discussed above might not be fully addressed by any of the features described herein.

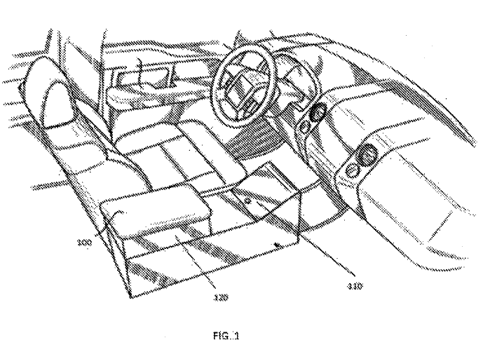

In accordance with the above, FIG. 1 illustrates a typical automotive console utility box 110 that is conventionally located between the two front seats and supports an armrest 100 on its top for the occupants to rest their arms on while seated in the vehicle. The armrest 100 along with the console utility box 110 forms a storage compartment 120 may be provided for storage purposes. For accessing the storage compartment, the armrest 100 can be opened, wherein it angularly moves in the vertical plane a use position to a non-use position. The use position of the armrest 100 refers to the substantially horizontal position when the armrest 100 is in closed condition and there is no access to the storage compartment 120. On the other hand, the non-use position of the armrest 100 is the vertical position when the armrest 100 is in open state and the storage compartment 120 can be partially or fully accessed.

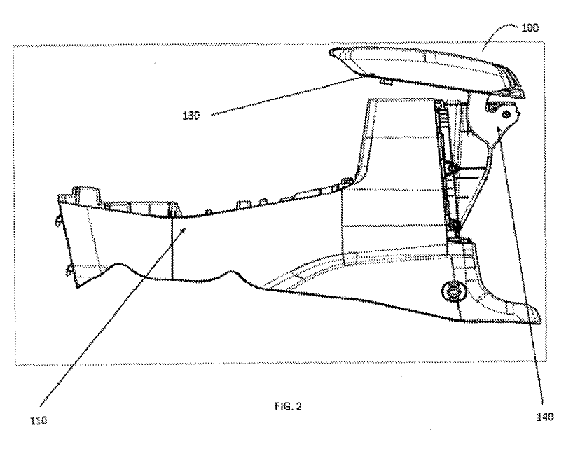

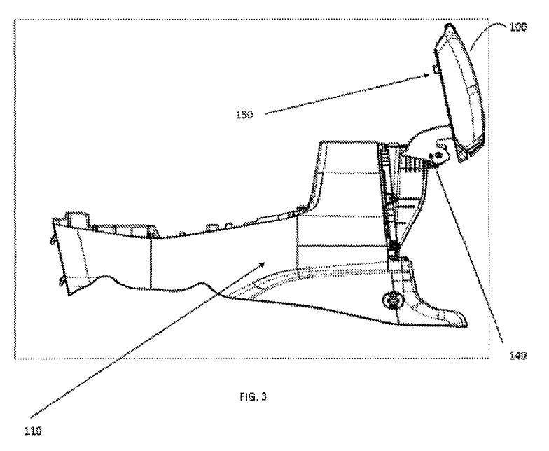

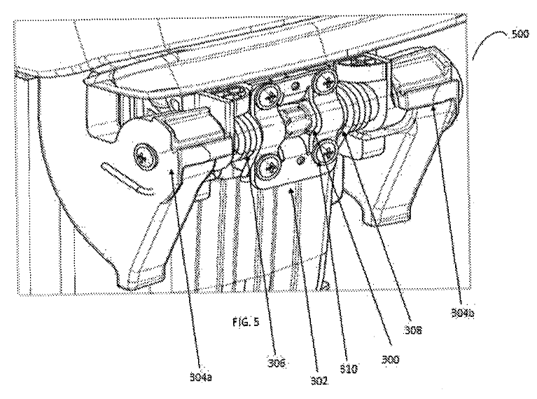

FIG. 2 and FIG. 3 demonstrate the pivotal movement of the armrest 100 from the substantially horizontal position to the substantially vertical position. Further, the armrest 100 comprises an armrest assembly 130 and an armrest hinge 140. Further, FIG. 2 and FIG. 3 demonstrate the armrest hinge 140 which is pivotally fixed with the console utility box 110. In an embodiment, the armrest assembly 130 and the armrest hinge 140 may form a single unit to form a single/integrated armrest 100. In another embodiment, the armrest assembly 130 and the armrest hinge 140 may be a compound unit to form a single armrest 100. In an embodiment, the armrest hinge 140 may further comprise a collar like structure to provide a holding arrangement for the controlled movement of the armrest through the unique and distinct pivot arrangement. The unique pivot arrangement would be described in the subsequent paragraph's with the help of FIG. 5. Also, as illustrated in FIG. 5, said damper plate assembly 302 comprises at least two flange for the controlled movement, wherein said flange is attached to each side of damper plate assembly 302 to facilitate non-damped or free movement of the same. In the preferred embodiment, one of the at least two flange is attached on the outer side of the damper plate assembly 302 and the other flange is attached on the inner side of the damper plate assembly 302.

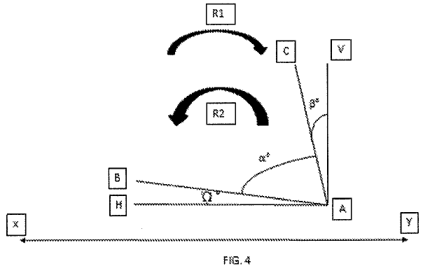

As shown in FIG. 4, the surface XY represents the top of the console utility box 110 where the armrest 100 is pivotal by the pivot arrangement. Point A represents the pivot joint between the armrest and the console utility box. FIG. 4 further demonstrates that the armrest 100 forms an angle with the surface XY of the console utility box when in open or closed or use or non-use positions, wherein the angles vary between 0° to 90°. The controlled and non-jerky angular movement of the armrest 100 from the reference point H, 0° (use position) to the reference point V, 90° (non-use position) is controlled by the uniquely designed pivot arrangement positioned at A in FIG. 4. The invention encompasses other embodiments where the angle between use and non-use positions extend beyond 90° or less than 90°, depending upon the design and requirement. For example, the last angular non-position position may also be 80° with respect to the plane XY.

The “controlled movement” of the armrest 100 herein referred as the movement of the armrest 100 is damped in at least one specific angular range and non-damped or free movement of the armrest 100 in at least one angular range different than the angular range where the movement is damped. For example, the free angular range may be during the initial angular range of the movement from the armrest 100, just after the knob of the armrest 100 is released and during the last lag of the movement. Similarly, the damped movement may be in between the initial and the last lag of the movement which would be different than the angular range of the damped movement. In angular range terms, as described in the FIG. 4, the angular range α° may vary from 10° to 80°, may be the damped movement range for the armrest 100 and the free movement range may be ‘Ω̨° that varies from from 0° to 10° and β° or from 80° to 90°. The clockwise direction R1 represents the movement during the opening of the armrest 100 from the use position to the close positon while the opposite direction R2 represents the movement during the closing of the armrest 100.

The “damped movement” herein referred as the restricted movement of the armrest 100 thereby the user can stop the armrest 100 at its desired angular position of interest based on its requirement, that this desired angular position lies in between the damped angular range, i.e. α. The pivot arrangement is such uniquely designed such that a specified external force is required to move the armrest to its desired position and the armrest 100 pivots to the desired angular position, thus providing the ease of comfort to the user.

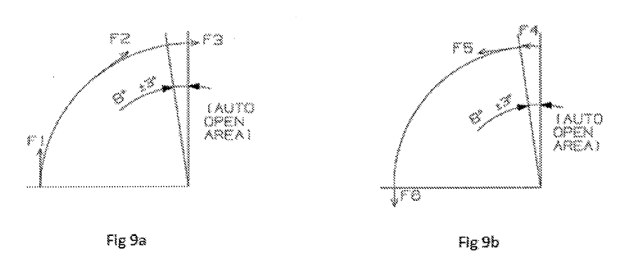

The present invention encompasses varied forces to be operated on the armrest at various positions. As shown in figure FIGS. 9a and 9b that illustrate various requirements of the operation forces on the armrest as encompassed by the invention. The force required at the lock release of the armrest varies from 20 Newton to 25 Newton. The force required for facilitating the rotation mechanism of the armrest, different forces are required. At open operation, the force F1 varies form 6 Newton to 10 Newton; force F2 varies for 3.5 Newton to 7.5 Newton while varying the force F between a value of (F2−3+2) Newton and (F2−3−2) Newton. A close operation, the force F6 varies from 1 Newton to 5 Newton; force F5 varies for 3.5 Newton to 7.5 Newton while varying the force F4 between a value of (F5+7+2) Newton and (F2+7−2) Newton. Further, the sliding armrest operation may require a force of value ranging from 13 Newton to 7 Newton.

FIG. 5 illustrates a closer view of the pivot arrangement 500 between the console utility box 110 and the armrest 100. Further, the armrest hinge 140 that forms with the armrest assembly 130 for facilitating pivot arrangement at the armrest 100 relative to the console utility box 110 through this pivot arrangement 500 is also clearly been demonstrated. The pivot arrangement 500 for the controlled movement of the armrest 100 comprising an elongated shaft 300, a damper assembly 302 and a spring assembly 306. The spring assembly 306 comprising at least one spring member for providing a biasing to the armrest 100 with shaft 300 and damper assembly 302. The elongated shaft 300, a damper assembly 302 and a spring assembly 306 are functionally associated and operable to provide the controlled angular movement of the armrest 100. In an exemplary embodiment, the damper assembly 302 provides required forces at required intervals of time. The rear end of the console utility box 110 and the armrest hinge 140 are pivotally fixed through the shaft 300 to provide angular pivot means. The two ends of the shaft 300 are received or engaged at the collars 304a, 304b of the console utility box 110 to provide an angular pivot means for the armrest 100. The collars 304a and 304b are made at the rear end of the armrest 100 in such a way that they are capable of receiving the two ends of the shaft 300. The shaft ends are received within the cavities of the collar 304a and 304b. The collar 304a, 304b feature on the armrest are provided with splines on the internal surface marking the cavity within the collars 304a and 304b. The shaft 300 also possesses splines at the two ends on its external surface such that they mesh with the splines of the collars 304a, 304b and prevents rotation of the shaft 300 relative to the collars 304a, 304b.

The shaft assembly 300 is coupled to and engaged by the damper assembly 302, wherein the damper assembly 302 are fixed to the rear end of the console utility box 110 by the help of nut and screw arrangement 310. The shaft assembly 300 has at least one coupling portion characterized in having alternate flat and curved edges along the circumference of the coupling portion on the outer surface. The number and design/shape of the alternating flat and curved edges gives a polygonal look to the coupling portion of the shaft 300 when seen in a cross-sectional view. In other words, the elongated shaft 300 bears a polygonal circumference towards its outer surface, extending across at least one at one position along the length of the shaft 300, wherein said polygon has upto 8 sides. In another embodiment, the entire length of the shaft 300 may be provided with the polygonal circumference. The person skilled in the art would appreciate that the number of polygonal coupling circumference may altered depending upon the easy of manufacturing and the requirement.

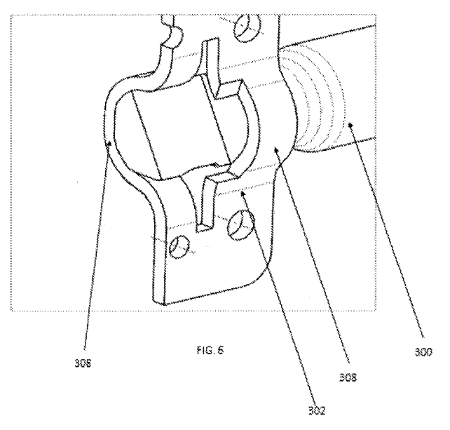

As depicted in the FIG. 6, the inner surface of the damper members 308 couples with the polygonal coupling circumference portion on the shaft 300 in such a way that the rotational movement of the shaft 300 is controlled by the interaction between the polygonal coupling circumference and the inner surface of the damper assembly 302. The movement is damped within a specific angular range, which in turn results in controlled angular movement of the armrest 100.

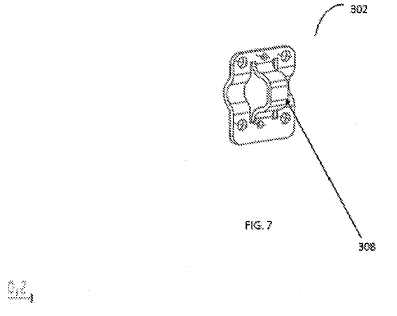

As depicted in the FIG. 7, the damper assembly 302 comprises at least one semi-circular damper member 308, the inner surface of which is such designed to functionally interact with said at least one outer polygonal surface on the shaft 300. In a preferred embodiment, the number of damper members 308 in the damper assembly 302 is three and they provide the interaction between the damper assembly 304 and the shaft assembly 300 to configure the controlled movement of the armrest 100. In another embodiment, the number of damper member 308 may be equal to the number of polygonal coupling circumference on the shaft 300.

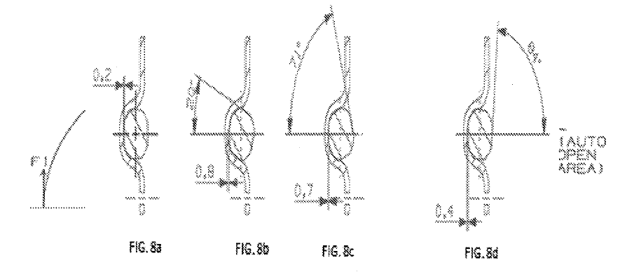

The amount of the interactions between the shaft 300 and the damper member 308 at the various angular movement ranges are depicted in the FIG. 8. The amount of interaction is produced on a scale of 0 to 1, i.e. 0 amount to zero interaction and 1 amounts to highest interaction. FIG. 8a depicts, the interaction of 0.2 when armrest is in use position or closed position. FIG. 8b depicts, the interaction of 0.8 when the angle marked by the armrest 100 at the console utility box 110 is 20 degrees. Similarly, FIG. 8c depicts the interaction of 0.7 when the angle marked is 71 degrees while the interaction of 0.4 when the angle is 84 degrees. Thus, it can easily be interpreted that the interaction in the free movement is less than the interaction during the damped movement.

The mechanism of operation of the armrest 100 is explained in the following paragraphs using FIGS. 4, 5, and 8.

FIG. 4, at reference point H, the armrest 100 is in the use position and may be initially locked with a knob or lock to the console utility box 110. The armrest 100 may then be opened by an occupant via unlocking or by releasing the knob in the armrest or console, with this initial action from the occupant the armrest 100 may come to a specific angular position ‘Ω̨° while making an angle, for example 10° (reference point B in FIG. 4), from the hinge. This movement from locking position to the ‘Ω̨° is characterized as a first free movement of the armrest 100. As depicted in the FIG. 4, the armrest 100 moves in the direction R1 from the use position to the non-use position. The armrest 100 movement from the substantial horizontal position (reference point B) to a substantially vertical position (reference point V) may be categorized in two parts of the angular range, a damped movement between reference points B to C marking an angular range α, and a second free movement marking an angular range β and beyond the reference point C, from where the armrest automatically gets to the reference point V even without any efforts/input from the occupant. The damped movement during the angle range α occurs due to interaction of the coupling portion of the shaft 300 with the damper plate 302 at specific orientation and specific positions. The amount of interaction is maximum in the angle range α, i.e. within the reference points B and C as shown in FIG. 8b and is also described in above paragraphs.

An angular range β marks for free movement of the armrest 100 and the same can be attributed to specific orientation and position of the coupling portion of the shaft 300 against the damper plate 302. The free movement requires minimal interaction or at least minimal interaction of the curved edges of the coupling portion to ensure minimal hindrance/friction which in turn causes free movement, as shown in FIG. 8d.

An intermediate point referred to herein as the metastable point is demonstrated as reference point C in FIG. 4, when the torque caused by the restoring force (MR) from the spring 306 and the torque caused by the weight (MG) balance out each other.

The amount of interaction of the coupling portion with the internal surface of the damper plate is least in the close and fully open state of the armrest, see reference point A and H in FIG. 4, as shown in FIG. 8a and FIG. 8d.

Further, beyond the reference point C, the restoring force (MR) by the spring 306 is greater than torque caused by the weight (MG), the armrest automatically moves towards the vertical position i.e. at reference point V. At this point, the amount of interaction between the shaft and the damper plate is comparatively less than that at any position between reference point B and C, as shown in FIG. 8c.

Similarly, a combined effect of the forces and interaction between the shaft 300 and the damper assembly 302 leads to controlled angular movement of the armrest during closing operation also.

In an embodiment, the shaft 300 may be made up of any suitable material such as plastic, teflon, metal or any such substance and combination thereof. In an embodiment, the damper assembly 302 may be made up of any suitable material such as plastic, teflon, metal or any such substance and combination thereof. In an embodiment, the spring assembly 306 may be made up of any suitable material such as plastic, teflon, metal or any such substance and combination thereof. In an embodiment, the armrest assembly 130 and the hinge 140 may be made up of any suitable material such as steel; however, in a preferred embodiment it is made up plastic

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms. Thus, various modifications are possible of the presently disclosed system and process without deviating from the intended scope and spirit of the present invention. Accordingly, in one embodiment, such modifications of the presently disclosed system and method are included in the scope of the present invention.

What is claimed is:

1. An armrest having a controlled movement pivoted to the console utility box of a vehicle, the armrest comprising:
an armrest assembly and an armrest hinge of the armrest assembly;
an elongated shaft guided through the armrest assembly with the console utility box of the vehicle, wherein the shaft bearing a polygon circumference towards its outer surface, at least at torsion spring one position along the length of the shaft;
a damper plate assembly fastened on the console utility box which functionally interacts with said at least one outer polygonal surface on the shaft to provide the damping effect on the controlled movement of the armrest in a specific angular range; and
a spring assembly functionally engaged with the armrest assembly, the hinge of the armrest assembly, the shaft and the damper assembly to facilitate controlled movement of said armrest.

2. An armrest having a controlled movement pivoted to the console utility box 110 of a vehicle as claimed in claim 1, wherein said polygon circumference has up to 8 sides.

3. An armrest having a controlled movement pivoted to the console utility box of a vehicle as claimed in claim 1, wherein a damped movement in at least one specific angular range of the controlled movement of said armrest 100, and a non-damped movement in at least one different specified angular range of the controlled movement of said armrest.

4. An armrest having a controlled movement pivoted to the console utility box of a vehicle as claimed in claim 1, wherein said damper plate assembly comprises at least two flange for controlled movement.
